(19) United States
(12) Patent Application Publication
(10) Pub. No.: US 2013/0312707 A1
(43) Pub. Date: Nov. 28, 2013

(54) LPI FUEL SYSTEM AND RETURN FUEL MINIMIZING METHOD

(71) Applicant: HYUNDAI MOTOR COMPANY, Seoul (KR)

(72) Inventor: Changho HAM, Ansan-si (KR)

(73) Assignee: Hyundai Motor Company, Seoul (KR)

(21) Appl. No.: 13/668,873

(22) Filed: Nov. 5, 2012

(30) Foreign Application Priority Data
May 24, 2012 (KR) 10-2012-0055239

(51) Int. Cl. F02D 1/02

(52) U.S. Cl. CPC F02D 1/02
USPC 123/457

(57) ABSTRACT

A return fuel minimizing logic of a fuel pump may include:, after the fuel pump may be driven by detecting a key-on (IG ON) of engine, the pressure difference ΔP (=the bombe fuel pressure Pbombe−the fuel injection pressure Pinjector) may be detected, and then the target pressure ΔPtarget may be set to the engine starting pressure Pstart or at least four different engine running pressures Prunning so that the duty can be maintained, increased or decreased by controlling the fuel pump to optimize the flow rate discharged from the pump, considering the difference of the magnitude between the pressure difference ΔP and the target pressure ΔPtarget, by which the return flow rate which may be affected by the engine heat and the air temperature, can be reduced.

### CROSS-REFERENCE(S) TO RELATED APPLICATIONS

The present application claims priority to Korean Patent Application No. 10-2012-0055239, filed on May 24, 2012, the entire contents of which is incorporated herein for all purposes by this reference.

### BACKGROUND OF THE INVENTION

1. Field of the Invention

Exemplary embodiments of the present invention relate to an LPI fuel system, and particularly to an LPI fuel system which adopts a method for minimizing return fuel so that both an operability of a fuel pump and a filling performance of a bombe can be improved by varying a fuel discharge rate, depending upon whether an engine is ignited or not, and by optimizing a fuel discharge rate of the fuel pump through a feedback-control based on a load condition of engine after the engine is started.

2. Description of Related Art

In general, an LPI (Liquefied Petroleum Injection) engine has a characteristic different to an LPG engine, in that in the case of the former, fuel is fed to it as a liquid state, while in the case of the latter, fuel is fed to it as a gaseous state.

Thus, the LPI engine is required for a bombe (or a vessel) for liquefying gas and filling it, similar to the LPG engine, but, in the LPI engine, fuel should be supplied to it so that fuel can be maintained as a predetermined liquid state from the bombe to an injector, similar to a gasoline engine.

Due to such fuel supplying characteristics, in the LPI engine, the residual fuel, which is not consumed by the engine of fuels discharged from the bombe to the engine, should be returned to the bombe. Thus, the existing LPI fuel system should be provided with an additional fuel return apparatus, in addition to a fuel supplying apparatus.

Generally, a return flow rate is defined as a value which subtracts a fuel consumption rate of engine from a discharged flow rate of the fuel pump, in which the discharged flow rate of the fuel pump is determined by a magnitude summing a safety factor to the fuel consumption rate in the engine fuel. As a result, the discharged flow rate of the fuel pump becomes larger than the fuel consumption rate.

Accordingly, in the LPI engine, the return flow rate is essentially generated, and in particular, when the engine is in a low load idle state, a large return flow rate is generated.

In order to solve this problem, a typical fuel return apparatus is required for a fuel return line having an inner diameter of about 6 mm.

However, since the return fuel which is not consumed by the engine after it is discharged from the bombe is returned to the bombe in a manner that it is heated by the heat of the engine and the air temperature, it leads to a lowering of the filling performance of the bombe.

In particular, since the flow rate discharged from the fuel pump in the LPI engine is larger than the fuel consumption rate, the residual fuel which is not used by the engine should be returned to the bombe.

Accordingly, the fuel pump discharges fuel by a magnitude summing a safety factor to the fuel consumption rate of the engine, it results in an increasing of the noise of the pump and a lowering of its durability.

As an example, also in the case of the fuel pump, since an amount of fuel which is larger than the fuel consumption rate is discharged, a noise is generated by the fuel pump and the durability of the fuel pump can be lowered, and when the engine is in an idle state of a low load, a large quantity of return flow causes the temperature to rise, by a heat of the engine and the air temperature, then it is returned to the bombe, it leads to a lowering of the filling performance of the bombe.

In particular, the return fuel which is returned to the bombe with a raised temperature while flowing through the fuel return line having the inner diameter of about 6 mm, causes the temperature of the bombe to rise, by which a liquid-phase fuel is vaporized and the pressure inside the bombe is raised.

Due to such temperature and pressure risings inside the bombe, it is adversely affecting the filling performance of the LPG fuel in which a propane proportion having a higher evaporating pressure is larger than that of butane.

Thus, the conventional solutions have not been able to overcome various problems resulted from the LPI with a fuel return line system having the inner diameter of about 6 mm. Accordingly, a need exists for a system to provide new and innovative features that overcome the shortfalls of the existing methodologies.

Exemplary embodiment of the present invention is to provide an LPI fuel system for decreasing a return fuel which is returned to the bombe while preventing a malfunction of the fuel pump by differentiating the fuel discharge rate of the fuel pump based on the engine starting condition (i.e., on or off) and by optimizing the fuel discharge rate of the fuel by a feedback control based upon a load condition of the engine after the engine has been started. In particular, the present invention can provide an LPI fuel system adopting a method for minimizing return fuel so that both an operability of a fuel pump can be improved and a flow rate returned to the bombe, by varying a fuel discharge rate, depending upon whether an engine is ignited or not, and by optimizing the a fuel discharge rate in the fuel pump through a feedback control based upon the load condition of the engine after the engine is started.

According to the present invention, the fuel return line which does not affect the heat of the engine or the air temperature is constructed by embodying a small quantity of return flow rate, and thus there is provided an LPI fuel system incorporating a return fuel minimizing scheme whereby it is possible to prevent a lowering of the filling performance of the bombe due to the return fuel.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for minimizing return fuel in an LPI system comprising recognizing a fuel discharge rate and calculating a pressure difference ΔP when a bombe fuel pressure Pbombe and an injector pressure Pinjector are detected after a fuel pump is driven in a key-on (IG ON) state of engine, and controlling the fuel pump in which, after the pressure difference ΔP is calculated, the bombe fuel pressure Pbombe is compared with the injector pressure Pinjector, and a flow rate discharged from the fuel pump is maintained at a constant pressure.

In accordance with an embodiment of the present invention, the pressure difference ΔP is a value which subtracts the bombe fuel pressure Pbombe from the injector pressure Pinjector.

In accordance with another embodiment of the present invention, controlling the fuel pump may include verifying the fuel discharge rate, in which, after the pressure difference ΔP is calculated, a target pressure ΔPtarget is set differently, depending upon whether the engine is ignited or not, optimally controlling the fuel discharge rate, in which, after the pressure difference ΔP and the target pressure ΔPtarget are compared with each other, a duty of the fuel pump is set to a different value, depending upon any difference of magnitude between the pressure difference ΔP and the target pressure ΔPtarget.

In accordance with another embodiment of the present invention, a determination as to whether the engine is in the ignition-on state or not, is based on the number of revolutions (RPM) of engine.

In accordance with another embodiment of the present invention, when it is judged that the engine is in the ignition-off state, the target pressure ΔPtarget is set to an engine starting pressure Pstart, while when it is judged that the engine is in the ignition-on state, the target pressure ΔPtarget is set to an engine running pressure Prunning.

In accordance with another embodiment of the present invention, when the target pressure ΔPtarget is set to the engine running pressure Prunning, the target pressure ΔPtarget is applied as a fixed pressure regardless of the condition of an engine load or as a variable pressure which is differentiated depending upon a load of engine.

In accordance with another embodiment of the present invention, when the target pressure ΔPtarget is applied as a variable pressure which is differentiated depending upon a load of engine, the target pressure ΔPtarget is divided into at least four different values.

In accordance with another embodiment of the present invention, at least four different values of the target pressure ΔPtarget are based on both a change for the load of engine and a change of the number of revolutions of engine, so that four different values can be selected, by matching the change for the load of engine with the change of the number of revolutions of engine.

In accordance with another embodiment of the present invention, in any area, the magnitude of the load of engine may have a value ranging from a smaller value to a larger value, and the magnitude of the number of revolutions of engine is divided by a value ranging from a smaller value to a larger value.

In accordance with another embodiment of the present invention, when the magnitude of the load of engine may have a small value, the magnitude of the number of revolutions (RPM) of engine also may have a small value, and when the magnitude of engine may have a large value, the magnitude of the number of revolutions (RPM) of engine also may have a large value.

In accordance with another embodiment of the present invention, when the magnitude of the load of engine and the magnitude of the number of revolutions (RPM) of engine may have the smallest value of the four areas, the target pressure ΔPtarget is defined as a setting pressure P1, when the magnitude of the load of engine and the magnitude of the number of revolutions of engine may have the largest value of the four areas, the target pressure ΔPtarget is defined as a setting pressure P4, the remaining two areas are set between the smallest value selected from the four areas and the largest value selected from the four areas, and those remaining two areas are defined as P3 and P4, respectively, based on a difference between the magnitude of the load of engine and the magnitude of the number of revolutions of engine, and the magnitudes of the setting pressures P1 to P4 may have the following relationship P4>P3>P2>P1.

In accordance with another embodiment of the present invention, when the pressure difference ΔP is equal to the target pressure ΔPtarget, the fuel pump is controlled in a direction that the duty is constantly maintained without decreasing or increasing it, when the pressure difference ΔP is less than the target pressure ΔPtarget, the fuel pump is controlled in a direction that the duty is increased, and when the pressure difference ΔP is greater than the target pressure ΔPtarget, the fuel pump is controlled in a direction that the duty is decreased.

Another embodiment of the present invention is directed to an LPI fuel system adopting the return fuel minimizing method comprising a fuel pump which is installed in a bombe with a pressure sensor, a fuel supplying line which is connected from the fuel pump to an injector of the engine and is provided with a relief valve and a shut-off valve, a fuel return line which is connected from the injector to the bombe fuel pump and is provided with a return valve which is installed in the bombe, an engine control unit (ECU) having a logic means for minimizing fuel which is returned to the fuel return line in a manner that is not consumed in the injector, by controlling a discharge flow rate of the fuel pump.

In accordance with an embodiment of the present invention, the return valve may include an orifice provided on a fuel path for flowing the fuel returned to the fuel return line, a check valve for opening or closing the fuel path inside a valve body connected to the fuel path, and a plunger coupled with the valve body for discharging the return fuel passing through the check valve.

Another object of the present invention is to provide to an LPI fuel system adopting the above-mentioned method for minimizing return fuel comprising a fuel pump which is installed in a bombe with a pressure sensor, a fuel supplying line which is connected from the fuel pump to an injector of the engine and is provided with a relief valve and a shutoff valve, a fuel return line which is connected from the injector to the bombe fuel pump and is provided with a return valve which is installed in the bombe, an engine control unit (ECU) having a logic means in which the return fuel, which is returned to the fuel return line in a manner that is not consumed in the injector, is minimized by controlling a discharging flow rate of the fuel pump.

In accordance with one embodiment of the present invention, the return valve may include an orifice provided at a fuel path to which the return fuel which is returned to the fuel return line is flowing, a check valve for opening or closing the fuel path inside a valve body connected to the fuel path, and a plunger coupled with the valve body so that the return fuel passing through the check valve can be discharged.

In accordance with the present invention, it is possible to prevent increasing the noise of the pump and lowering its durability by optimizing the a fuel discharge rate in the fuel pump through a feedback control, depending upon the load of engine when the engine is started, and to decrease a return flow rate which is returned to the bombe based on the optimized fuel discharge rate.

In accordance with the present invention, since a current consumption of the fuel pump is reduced by minimizing the discharge rate, an LPG vehicle fuel efficiency can be enhanced.

In accordance with the present invention, since the return flow rate which is returned to the bombe is reduced by optimizing the discharge flow rate into the fuel pump, the filling performance of the LPG fuel can be prevented, by which the LPG fuel which has a propane proportion having a higher evaporating pressure than that of butane, can be filled without lowering the filling performance.

Also, according to the present invention, since a diameter of the fuel return line becomes smaller and a pressure regulator can be removed by decreasing the return flow rate, it is possible to build the system at a relatively inexpensive cost.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram for explaining a minimized logic of an LPI fuel system according to an exemplary embodiment of the present invention.

FIG. 2 is a schematic diagram showing the LPI fuel system adopting a minimizing scheme of the return fuel according to an exemplary embodiment of the present invention.

FIG. 3 is a graphical diagram for explaining a phase change of some LPG fuel showing a pressure difference established by the return fuel minimizing scheme according the present invention.

FIG. 4A and FIG. 4B show a target pressure determining method for embodying the return fuel minimizing scheme according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

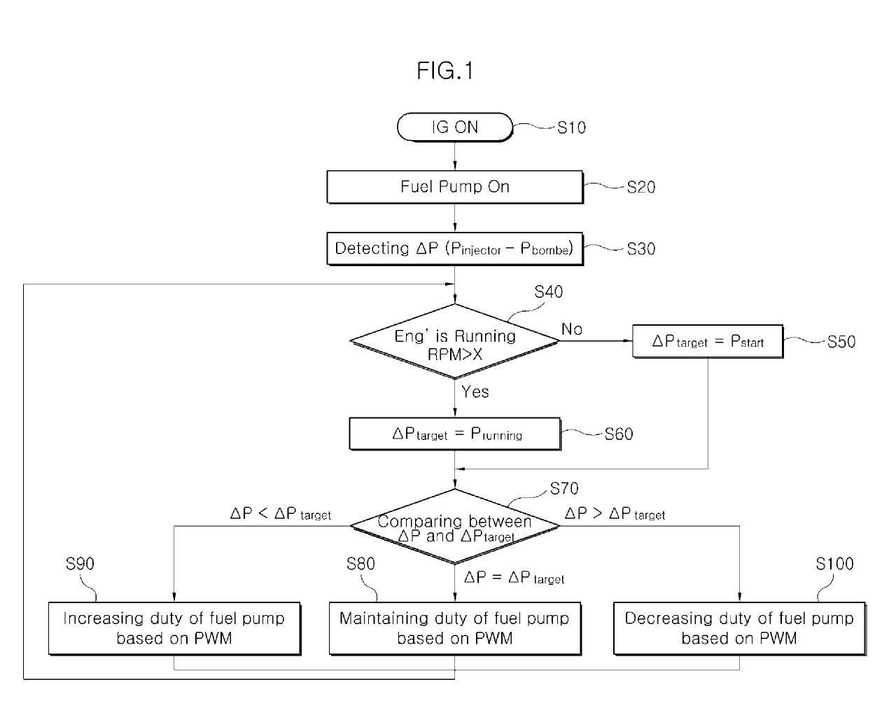

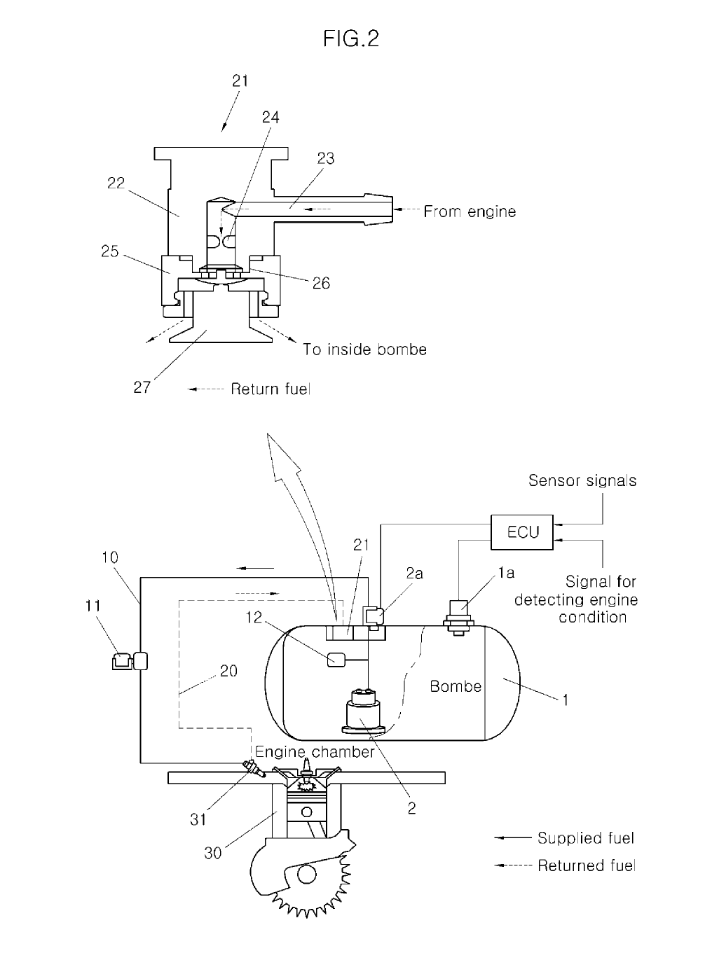

FIG. 1 is a block diagram for explaining a return fuel minimizing logic of an LPI fuel system according to an exemplary embodiment of the present invention, and FIG. 2 is a schematic diagram showing an LPI fuel system according to an exemplary embodiment of the present invention.

Hereinafter, principal components of the return fuel minimizing logic of the LPI fuel system will be described in connection with FIG. 2.

As shown, when a key-on IG ON for starting an engine is detected (S10), a fuel pump is changed to a turn-on state to be driven (S20).

In general, a driving of the fuel pump, upon recognition of the key-on, is implemented by an engine control unit (ECU).

As apparent from the LPI fuel system, the fuel pump 2 is installed in a bombe 1, in which the ECU sends a signal to a driver 2a to drive the fuel pump 2.

Then, a pressure of fuel which is fed from the bombe 1 to an engine 30 is checked, so that a pressure difference ΔP (=Pinjector−Pbombe) between the fuel pressure Pbombe and the injector pressure Pinjector for injecting the fuel into the engine, can be detected.

Such processes are performed thorough a logic means which is built in the ECU.

The ECU receives a signal from a pressure sensor la which is installed in the bombe 1 to detect the internal pressure inside the bombe 1, and receives a signal from an injector 21 for injecting fuel which is fed from the fuel pump 2 to a fuel supplying line 10 to detect the fuel injection pressure of the injector 21.

Typically, the fuel injection pressure of the injector 21 is detected based on the fuel sensor which is installed in the injector 21.

The internal pressure of the bombe 1 is defined as the bombe fuel pressure Pbombe, and the fuel injection pressure of the injector 21 is defined as the injector pressure Pinjector, respectively.

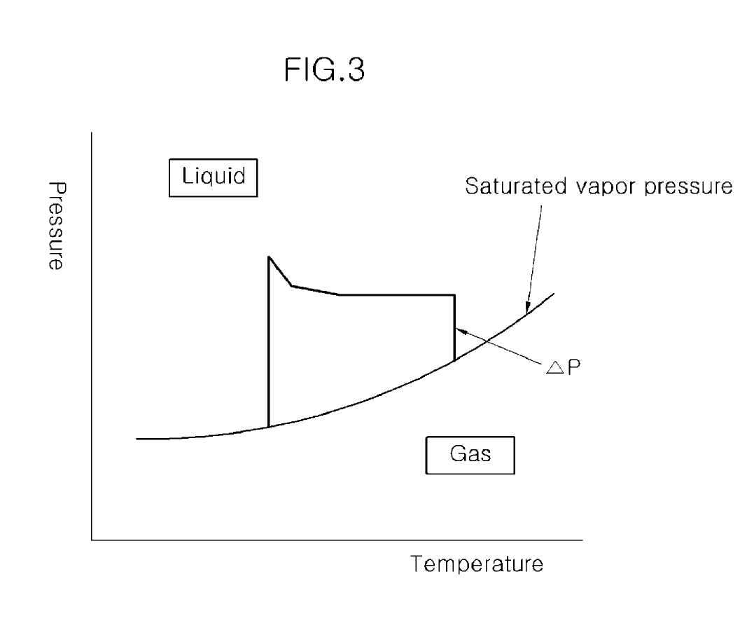

The pressure difference ΔP is depicted on FIG. 3 showing a graphical diagram for explaining a phase change of the LPG fuel.

Then, the target pressure ΔPtarget is set depending upon whether the engine is started or not, in which a judgment as to whether the engine is started or not is determined by the following condition: the number of revolutions (RPM) of engine>X, wherein X denotes a predetermined number of revolutions of engine (S40).

In general, X which is indicative of a predetermined number of revolutions of engine has the number of revolutions of engine having a value of a zero or more, but it is not limited to any specific value because it is defined differently depending on the specification of the engine.

As a result of the check by the S30, when the engine 30 has not been started, the target pressure ΔPtarget is set to an engine starting pressure Pstart (S50).

That is, it is set to have a relationship that the target pressure ΔPtarget is equal to the engine starting pressure Pstart (i.e, ΔPtarget=Pstart), and is defined by a value which is different from the pressure difference ΔP detected in the S30.

However, as a result of the check by the S30, when the engine 30 has been started, the target pressure ΔPtarget is set to an engine running pressure Prunning (S60).

That is, it is set to have a relationship that the target pressure ΔPtarget equals to the engine running pressure Prunning (i.e, ΔPtarget=Prunning), and is defined by a value which is different from the pressure difference ΔP detected in the S30.

Under the condition of ΔPtarget=ΔPrunning according one embodiment of the invention, a fixed pressure or a variable pressure based on an engine load, may be used for ΔPtarget.

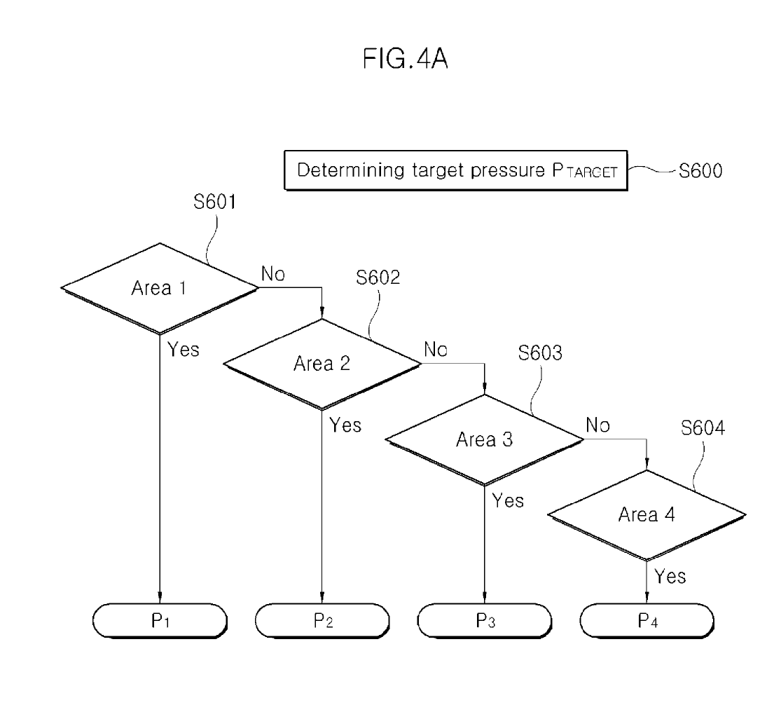

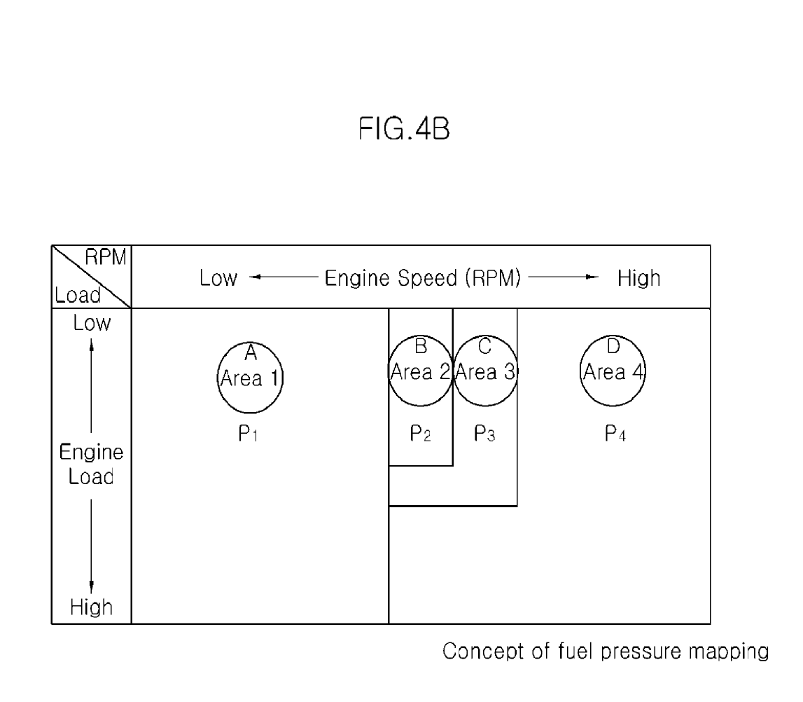

FIG. 4 shows a logic embodied by the ECU when the target pressure ΔPtarget is set as the variable pressure.

FIG. 4A illustrates an example that the target pressure ΔPtarget which is set as the variable pressure based on the engine load includes four areas divided by the number of revolutions of engine and the engine load, and the target pressure ΔPtarget is set differently in the respective four divided areas.

In general, the number of revolutions of engine is defined as RPM, and the engine load is defined as an indicated mean effective pressure (IMEP).

In a logic for determining the target pressure ΔPtarget, the engine load has a magnitude ranging from a smaller value to a larger value, and the number of revolutions of engine also has a magnitude ranging from a smaller value to a larger value (S600).

FIG. 4B illustrates a relationship between the engine load and the number of revolutions of engine. As apparent from FIG. 4b, when the number of revolutions(RPM) of engine has a small value, the engine load also has a small value, and when the number of revolutions (RPM) of engine has a relatively large value, the engine load also has a large value.

Therefore, the target pressure ΔPtarget is defined based on items including the number of revolutions (RPM) of engine in the case of a low speed, a low engine load, the number of revolutions (RPM) of engine in the case a high speed, and a high engine load, in which relations between those four items are set to at least four target pressures ΔPtarget which are different from each other, based on any fuel pressure mapping concept.

Generally, since the engine load and the number of revolutions of engine can be defined differently depending upon the specifications of the engine, it is not limited to any specific value.

The number of revolutions (RPM) of engine and engine load are judged in view of the lowest area 1, in which, when the number of revolutions (RPM) of engine and the engine load during their checking, satisfy a condition of the area 1, this is defined to a set pressure P1, and is set to have a relationship such as ΔPtarget=P1=Prunning (S601).

Then, the number of revolutions (RPM) of engine and engine load are judged in view of an area 2 which is relatively larger than the area 1, in which, when the number of revolutions (RPM) of engine and the engine load during their checking, satisfy a condition of the area 2, this is defined as a set pressure P2, and is set to have a relationship such as ΔPtarget=P2=Prunning (S602).

The number of revolutions (RPM) of engine and engine load are judged in view of an area 3 which is relatively larger than the area 2, in which when the number of revolutions (RPM) of engine and the engine load during their checking, satisfy a condition of the area 3, this is defined as a set pressure P3, and is set to have a relationship such as ΔPtarget=P3=Prunning (S603).

Next, The number of revolutions (RPM) of engine and engine load are judged in view of an area 4 which is relatively larger than the area 3, in which, when the number of revolutions (RPM) of engine and the engine load during their checking, satisfy a condition of the area 4, this is defined as a set pressure P4, and is set to have a relationship such as ΔPtarget=P4=Prunning (S604).

In summary, the magnitudes of the setting pressures preferably has a relationship such as P1<P 2<P3<P4<Phigh.

Also, FIG. 4B is a concept diagram showing that an area 1(A), an area 2(B), an area 3(C), and an area 4(D) are set to have a relationship that P1=Prunning, P2=Prunning, P3=Prunning, and P4=Prunning, respectively, based on the fuel pressure mapping concept, and these are set to ΔPtarget, respectively.

Next, the previously detected pressure difference ΔP is compared with the target pressure ΔPtarget to feed-back control the fuel pump 2 by the ECU, so that a flow rate which is discharged from the fuel pump can be maintained at a constant pressure, by controlling the fuel pump based on a uniform pressure control scheme (S70).

As one example, according to the fuel pump controlled by such a uniform pressure control scheme, it is possible to constantly maintain the discharge pressure at about 5 bar.

In one embodiment of the present invention, in order to perform to the uniform pressure control scheme, a comparison process between the pressure difference ΔP and the target pressure ΔPtarget includes three steps.

Then, when ΔP equals to ΔPtarget , though the ECU controls a duty of the fuel pump 2 based on a pulse width modulation (PWM) method, the fuel pump 2 is constantly maintained without decreasing or increasing the duty (S80).

Also, when ΔP is lesser than ΔPtarget, though the ECU controls a duty of the fuel pump 2 based on the PWM method, the fuel pump 2 is controlled in a direction that the duty is increased (S90).

Also, when ΔP is greater than ΔPtarget , though the ECU controls a duty of the fuel pump 2 based on the PWM method, the fuel pump 2 is controlled in a direction that the duty is decreased (S100).

As mentioned above, according to the return fuel minimizing logic of one embodiment of the present invention, after the fuel pump is driven by a key-on (IG ON) of engine, the pressure difference ΔP (=the bombe fuel pressure Pbombe−the fuel injection pressure Pinjector) is detected, and then the target pressure ΔPtarget is set to the engine starting pressure Pstart or at least four different engine running pressures Prunning so that the duty can be maintained, increased or decreased by controlling the fuel pump to optimize the flow rate discharged from the pump, considering the difference of the magnitude between the pressure difference ΔP and the target pressure ΔPtarget, by which the return flow rate which is affected by the engine heat and the air temperature, is reduced.

FIG. 2 shows the LPI fuel system adopting the return fuel minimizing scheme according to one embodiment of the present invention.

As shown, the LPI fuel system includes: a fuel pump 2 which is installed in a bombe 1 having a pressure sensor 1 a, a fuel supplying line 10 connected from the fuel pump 2 to an injector 31 of an engine 30, a relief valve 12 which is installed in the fuel supplying line 10 inside the bombe 1 before the fuel supplying line 10 gets out of the bombe 1, a shut-off valve 11 disposed between the injector 31 and the bombe 1 to which the fuel supplying line 10 is connected, a fuel return line 20 connected from the injector 31 to the fuel supplying line 10, a return valve 21 installed in the fuel return line 20 inside the bombe 1, and an engine control unit (ECU) having a logic means which duty-controls a discharge flow rate by a pulse width modulation (PWM) scheme, to minimize fuel which is returned from the fuel return line 20 to the bombe 1.

The fuel pump 2 is provided with a driver 2a, which is controlled by the ECU.

The fuel return line 20 has an internal diameter of about 2 mm which is smaller than that of a typical fuel return line having an internal diameter of about 6 mm, in which an existing pressure regulator which is provided in the fuel return line 20 is removed.

The return valve 21 includes a body housing 22 which is engaged to the bombe 1, an orifice 24 provided on a fuel path 23 by which a return fuel flows to the body housing 22, a valve body 25 coupled with the body housing 22 and connected to the fuel path 23, a check valve 26 for opening or closing the fuel path 23 inside the valve body 25, and a plunger 27 coupled with the valve body 25 for discharging return fuel passing through the check valve 26.

The orifice 24 has its internal diameter of about 0.2 mm and is provided on the fuel path 23. The check valve 26 is preferably a diaphragm type check valve. The return fuel minimizing logic which is built in the ECU is performed through S10 to S100.

According to the LPI fuel system constructed as described above, when the fuel pump 2 is driven through the ECU in the key-on (IG ON) state of engine, it is possible to use the fuel pump 2 to discharge an optimal flow rate, based on the difference of magnitude between the pressure difference ΔP (=the bombe fuel pressure Pbombe−the fuel injection pressure Pinjector) and the target pressure ΔPtarget (the engine starting pressure Pstart or at least four different engine running pressures Prunning).

The fuel discharged from the fuel pump 2 is fed to the injector 31 through the fuel supplying line 10, and then the injector 31 injects the fuel to the engine 30 to drive it.

In such processes, fuel which is not consumed by the engine, is returned to the return valve through the fuel return line 20, and the return fuel returned to the bombe 1 by passing through the orifice on the fuel path of the return valve is fed to the plunger 27 through the diaphragm type check valve.

The flow rate of return fuel can be performed through the fuel return line 20 having the internal diameter of about 2 mm, because a flow rate discharged from the fuel pump 2 is controlled at the minimum quantity by adapting to the number of revolutions of engine and thus the engine load and the return fuel which is not consumed by the engine is minimized.

As a result, since the flow rate of return fuel flowing to the fuel return line 20 to which the heat generated is transferred can be reduced at a small quantity, and the flow rate of return fuel which is returned to the bombe and the temperature can be reduced, it is possible to substantially suppress temperature and pressure rises occurring in the bombe 1 due to the return fuel.

Accordingly, even when the LPG fuel in the bombe fuel, in which a propane proportion having a high evaporating pressure is larger than that of butane, is used, it is possible to constantly maintain the filling performance of the LPG fuel.

As mentioned above, according to the LPI fuel system of one embodiment of the present invention, since the flow rate of return fuel flowing to the fuel return line 20 to which the heat generated is transferred can be reduced at a small quantity, the fuel return line 20 from the engine to the bombe can be performed by the small diameter of about 2 mm.

In accordance with the exemplary embodiments of the present invention, since a diameter of the fuel return line becomes smaller and a pressure regulator can be removed by decreasing the return flow rate, it is possible to build the system at a relatively inexpensive cost.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for minimizing return fuel in an LPI (Liquefied Petroleum Injection) system comprising:
determining a fuel discharge rate and determining a pressure difference ΔP when a bombe fuel pressure Pbombe and an injector pressure Pinjector are detected after a fuel pump is driven in a key-on (IG ON) state of an engine; and
controlling the fuel pump in which, after the pressure difference ΔP is determined, the bombe fuel pressure Pbombe is compared with the injector pressure Pinjector, and a flow rate discharged from the fuel pump is maintained at a constant pressure.

2. The method according to claim 1, wherein the pressure difference ΔP is a value which subtracts the bombe fuel pressure Pbombe from the injector pressure Pinjector.

3. The method according to claim 1, wherein controlling the fuel pump includes:
verifying the fuel discharge rate, in which, after the pressure difference ΔP is determined, a target pressure ΔPtarget is set differently, depending upon whether the engine is ignited or not; and
controlling the fuel discharge rate, in which, after the pressure difference ΔP and the target pressure ΔPtarget are compared with each other, a duty of the fuel pump is set to a different value, depending upon any difference of magnitude between the pressure difference ΔP and the target pressure ΔPtarget.

4. The method according to claim 3, wherein a determination as to whether the engine is in the ignition-on state or not, is based on the number of revolutions (RPM) of engine.

5. The method according to claim 3, wherein, when it is judged that the engine is in an ignition-off state, the target pressure ΔPtarget is set to an engine starting pressure Pstart, while when it is judged that the engine is in an ignition-on state, the target pressure ΔPtarget is set to an engine running pressure Prunning.

6. The method according to claim 5, wherein when the target pressure ΔPtarget is set to the engine running pressure Prunning, the target pressure ΔPtarget is applied as a fixed pressure regardless of a load of the engine or as a variable pressure which is differentiated depending upon the load of the engine.

7. The method according to claim 6, wherein, when the target pressure ΔPtarget is applied as a variable pressure which is differentiated depending upon the load of the engine, the target pressure ΔPtarget is divided into at least four different values.

8. The method according to claim 7, wherein the at least four different values of the target pressure ΔPtarget is based on both a change for the load of the engine and a change of the number of revolutions of the engine, so that four different values are selected, by matching the change for the load of engine with the change of the number of revolutions of the engine.

9. The method according to claim 8, wherein in the area, the magnitude of the engine load has a value ranging from a smaller value to a larger value, and the magnitude of the number of revolutions of the engine is divided by a value ranging from a smaller value to a larger value.

10. The method according to claim 9, wherein when the magnitude of the load of the engine has a small value, the magnitude of the number of revolutions (RPM) of the engine also has a small value, and when the magnitude of the engine has a large value, the magnitude of the number of revolutions (RPM) of the engine also has a large value.

11. The method according to claim 10, wherein when the magnitude of the engine load and the magnitude of the number of revolutions (RPM) of the engine have a smallest value of the four areas, the target pressure ΔPtarget is defined as a setting pressure P1; when the magnitude of the engine load and the magnitude of the number of revolutions of the engine have a largest value of the four areas, the target pressure ΔPtarget is defined as a setting pressure P4; the remaining two areas are set between the smallest value selected from the four areas and the largest value selected from the four areas, and those remaining two areas are defined as P3 and P4, respectively, based on a difference between the magnitude of the engine load and the magnitude of the number of revolutions of the engine; and the magnitudes of the setting pressures P1 to P4 have the following relationship: P4>P3>P2>P1.

12. The method according to claim 3, wherein, when the pressure difference ΔP equals the target pressure ΔPtarget, the fuel pump is controlled in a direction that the duty is constantly maintained without decreasing or increasing it; when the pressure difference ΔP is less than the target pressure ΔPtarget, the fuel pump is controlled in a direction that the duty is increased; and when the pressure difference ΔP is greater than the target pressure ΔPtarget, the fuel pump is controlled in a direction that the duty is decreased.

13. An LPI fuel system comprises:
a fuel pump which is installed in a bombe with a pressure sensor;
a fuel supplying line which is connected from the fuel pump to an injector of an engine and is provided with a relief valve and a shut-off valve;
a fuel return line which is connected from the injector to the fuel pump and is provided with a return valve which is installed in the bombe; and
an engine control unit (ECU) having a logic means for minimizing fuel which is returned to the fuel return line in a manner that is not consumed in the injector, by controlling a discharge flow rate of a fuel pump according to claim 1.

14. The LPI fuel system according to claim 13, wherein the return valve includes:
an orifice provided on a fuel path for flowing the fuel returned to the fuel return line;
a check valve for opening or closing the fuel path inside a valve body connected to the fuel path; and
a plunger coupled with the valve body for discharging the returned fuel passing through the check valve.
